(19) United States
(12) Patent Application Publication
(10) Pub. No.: US 2016/0096579 A1
(43) Pub. Date: Apr. 7, 2016

(54) Handlebars with Core

(71) Applicants: Douglas S. Nordberg, North Wildwood, NJ (US); Douglas A. Cain, Millville, NJ (US)

(72) Inventors: Douglas S. Nordberg, North Wildwood, NJ (US); Douglas A. Cain, Millville, NJ (US)

(21) Appl. No.: 14/507,948

(22) Filed: Oct. 7, 2014

(51) Int. Cl. B62K 21/12; B62J 27/00

(52) U.S. Cl. CPC B62K 21/12; B62J 27/00

(57) ABSTRACT

A handlebar for a motorcycle or bicycle or the like which will at least partially maintain its integrity even under an extreme load or as a result of an accident. The present handlebar has the same overall appearance of conventional handlebars with handles or hand grips at each end but further includes a core in the form of a cable that extends through the center of the handlebar. Each end of the cable is secured to the main part of the handlebar adjacent each end thereof in the vicinity of the handles. The cable will prevent pieces or sections of the handlebar from separating in the event of overloading or an accident and will at least partially maintain the shape or usefulness of the handlebars so as to provide some limited control of the vehicle in the event of overloading or in the event of an accident.

### BACKGROUND OF THE INVENTION

The present invention is directed toward handlebars such as may be used with a motorcycle, bicycle or the like and more particularly toward handlebars that may protect a rider of the vehicle or other riders from injury in the event of the breakage of the handlebars due to an accident or from some other extreme loading.

Handlebars for motorcycles, bicycles and the like have been in use for a very long time and have changed very little since the beginning. Conventionally, handlebars are comprised of an elongated tubular member, usually made of metal, extending substantially horizontally and including a hand grip at each end thereof to be held by the rider. Handlebars have been straight with the center connected to the front wheel of the vehicle for steering the same or have been bent in various configurations in order to fit the particular vehicle with which it is used and for the comfort of the rider.

In addition to metal tubular handlebars such as discussed above, composite handlebars have also been proposed. These may be made of various materials such as carbon, fiberglass, plastic or the like and are frequently built up utilizing multiple layers of such materials that may be held together with various resins or other plastic adhesives.

In any event, under extreme loads which can be caused by the rider putting too much pressure on the handlebars or as a result of a collision or the like, conventional handlebars have been known to break into pieces. This can cause injuries to the rider of the vehicle or to other riders in the vicinity. Furthermore, complete loss of control of the vehicle can occur when the handlebars break into sections.

There is, therefore, a need for improved handlebars for motorcycles or bicycles or the like that will not break into a number of pieces as a result of extreme loading or collision to thereby help prevent injury to the rider and to continue to provide at least some limited control of the vehicle.

### SUMMARY OF THE INVENTION

The present invention is designed to overcome the deficiencies of the prior art discussed above. Accordingly, it is an object of the invention to provide handlebars that improve safety.

It is a further object of the present invention to provide handlebars that improve safety and can be easily substituted for conventional handlebars without modification to the motor cycle or other vehicle.

It is a still further object of the present invention to provide handlebars that improve safety by helping to prevent injury and by allowing some limited control of a vehicle in the event of breakage of the handlebars.

In accordance with the illustrative embodiments demonstrating features and advantages of the present invention, there is provided a handlebar for a motorcycle or bicycle or the like which will at least partially maintain its integrity even under an extreme load or as a result of an accident. The present handlebar has the same overall appearance of conventional handlebars but includes a core therein in the form of a cable or the like that extends through the center of the handlebar. Each end of the cable is secured to the main part of the handlebar adjacent each end thereof in the vicinity of the handles. The cable will prevent pieces or sections of the handlebar from separating in the event of overloading or an accident and will at least partially maintain the shape or usefulness of the handlebars so as to provide some limited control of the vehicle in the event of overloading or in the event of an accident.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawing one form which is presently preferred; it being understood that the invention is not intended to be limited to the precise arrangements and instrumentalities shown.

FIG. 1 is a front elevational view of a first embodiment of a handle bar of the present invention, shown partially in cross-section;

FIG. 2 is a front elevational view of a second embodiment of the invention, and

FIG. 3 is a cross-sectional view taken through the lines 3-3 of FIG. 2.

### DETAILED DESCRIPTION OF THE PREFERRED EMBODIMENTS

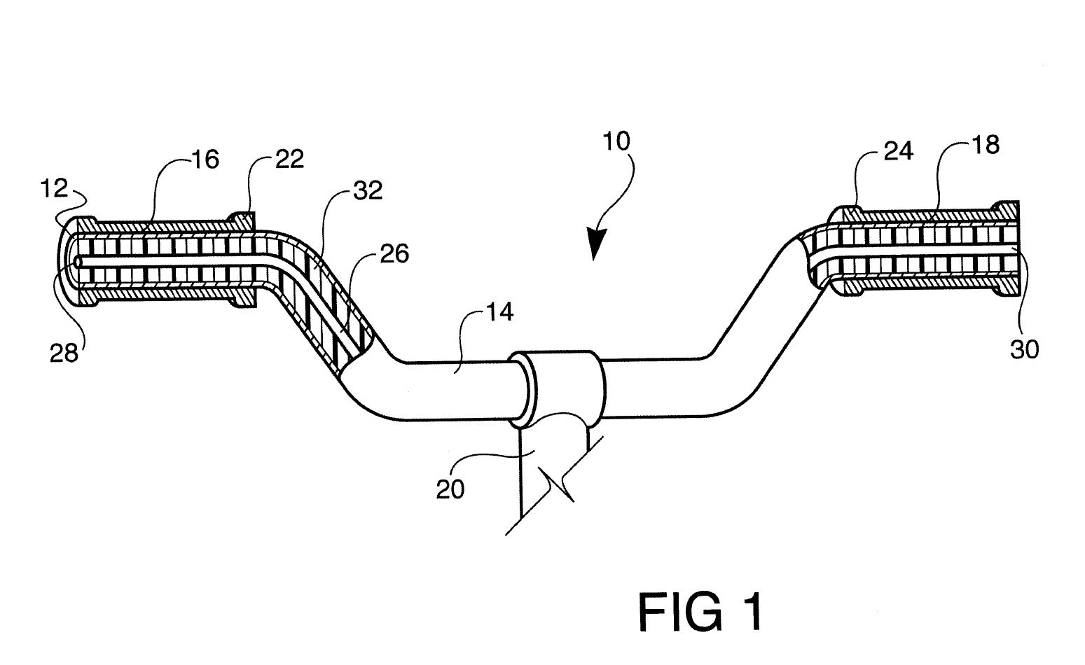

Referring now to the drawings in detail wherein like reference numerals have been used throughout the various figures to designate like elements, there is shown in FIG. 1 a first embodiment of handlebars constructed in accordance with the principles of the present invention and designated generally as 10. The overall appearance and construction of the handlebars 10 are somewhat conventional. The handlebars 10 of the first embodiment are comprised of an elongated tube 12 of steel or other material having a central portion 14 and end portions 16 and 18.

The end portions 16 and 18 are formed by bending the tube 12 upwardly and outwardly to have a conventional appearance. It is not beyond the scope of the present invention, however, to have the tube 12 be perfectly straight or bent into substantially any shape that allows them to be attached to a motorcycle or the like for steering the same and comfortably held by a rider.

In any event, the central portion 14 of the handlebars 10 are adapted to be attached to a motorcycle or bicycle utilizing a clamp 20 or other connecting means that is, per se, well known it the art. Furthermore, hand grips or handles 22 and 24, also well known in the art, are attached to the end portions 16 and 18, respectively, for the comfort of the rider.

The handlebars 10 described so far above are conventional. The present invention differs primarily in the use of a flexible cable 26 that extends through at least a substantial length of the interior of the tube 12. The cable 26 is preferably comprised of flexible stranded steel although other strong flexible materials may also be utilized. In each case, however, the ends 28 and 30 of the cable 26 are secured to the tube 12 at the end portions 16 and 18 adjacent to handles 22 and 24. This can be done by welding or the like or by some mechanical means such as a bolt and nut or a clamp. It is also within the scope of the invention to attach the cable 26 to the interior of the tube 12 at one or more positions along the length thereof.

A resin or other plastic material 32 may fill the interior of the tube 12 around the cable 26. This material 32 may help to strengthen the handlebars 10 and will also help to grip the cable 26. As should be readily apparent to those skilled in the art, the cable 26 and filler or resin 32 can be inserted into and secured to the tube 12 after it is bent into the shape shown in FIG. 1. Alternatively, the cable 26 and resin 32 can be inserted into the tube 12 while the tube is straight and the combination can then be bent into the desired shape.

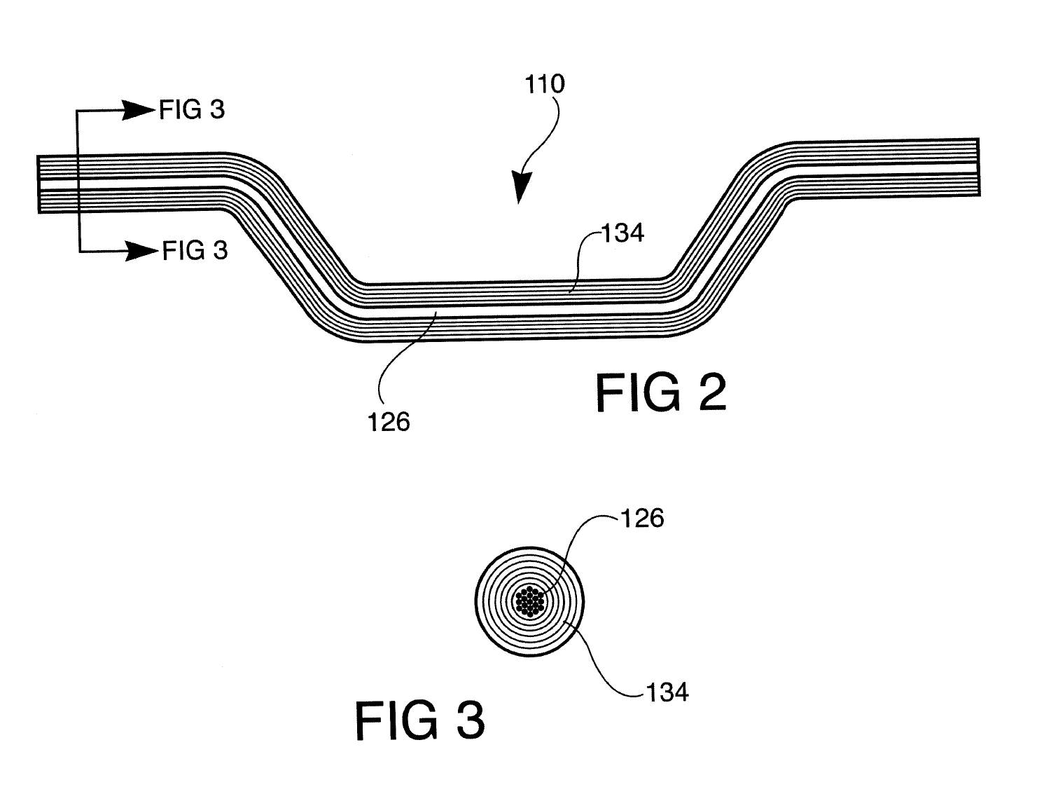

A second embodiment of the present invention is shown in FIGS. 2 and 3. In this embodiment, the handlebars 110 are built up from many layers of material. The handle bars 110 start with an elongate core 126. The core 126 is preferably flexible and made of stranded steel or other metal. It is possible, however, to make the core 126 of solid rather than stranded material and to make it from a strong fiber or plastic or other material.

Surrounding the core 126 are multiple layers 134 of material preferably impregnated with a resin or other plastic. The layers 134 may be in braided tubular form fitted over the core 126 or woven form that can be wrapped around the core 126, or combinations thereof. They can be comprised of various fabric materials made from fiberglass, carbon fibers or numerous other strong materials. In the preferred embodiment, the material forming the layers 134 is pre-impregnated with a resin or other plastic material although, the fabric could be impregnate after it is applied.

After one or more layers of fabric material 134 are applied to the core 126 and the resin is applied or pre-applied, the combination is heated or cured in an oven or press during which a vacuum can be applied to remove gases to form a solid cover without voids. This can be done multiple times as layers are applied or only once after all of the desired layers are applied.

As in the first embodiment, the handlebars 110 can be initially straight and then formed into the desired shape or can be formed in the desired shape as the various layers are being applied. In any event, the curing of the resin secures the core 126 to the remaining parts of the handlebars. If desired, the ends of the core 126 could be further attached to the ends of the handlebars but this would normally not be necessary as it securely grips the interior of the handlebars throughout the entire length thereof.

The present invention may be embodied in other specific forms without departing from the spirit or essential attributes thereof and accordingly, reference should be made to the appended claims rather than to the foregoing specification as indicating the scope of the invention.

1. (canceled)

2. The handlebar as claimed in claim 8 wherein said cable is a multi-stranded cable.

3. The handlebar as claimed in claim 8 wherein said cable is comprised of steel.

4. (canceled)

5. (canceled)

6. (canceled)

7. (canceled)

8. A handlebar for a motorcycle or bicycle comprising:
an elongated tubular cylindrical member having a central portion and first and second end portions, said cylindrical member terminating at said end portions;
said central portion being adapted to be connected to the steerable wheel of the vehicle;
said elongated cylindrical member being comprised of a continuous rigid tube extending from said first end portion, through said central portion, and to said second end portion;
first and second handles secured to said first and second end portions, respectively, said handles being adapted to be gripped by the rider of said vehicle;
a flexible cable extending through substantially the entire interior of said tubular member and being secured to the same at each end portion adjacent said handles, and
said cylindrical member being comprised of composite material built around said cable and being bonded to said cable substantially along the entire length of said cable.
